(19) United States
(12) Patent Application Publication
(10) Pub. No.: US 2020/0159460 A1
(43) Pub. Date: May 21, 2020

(54) Method and Apparatus for Selective Erase of Persistent and Non-Volatile Memory Devices

(71) Applicant: HEWLETT PACKARD ENTERPRISE DEVELOPMENT LP, Houston, TX (US)

(72) Inventors: Suhas Shivanna, Bangalore (IN); Clarete Riana Crasta, Bangalore (IN); Sumangala Bannur Subraya, Bangalore (IN)

(21) Appl. No.: 16/685,498

(22) Filed: Nov. 15, 2019

(30) Foreign Application Priority Data
Nov. 15, 2018 (IN) 201841043089

(51) Int. Cl. G06F 3/06; G06F 21/44; G06F 12/02

(52) U.S. Cl. CPC G06F 3/0659; G06F 3/0623; G06F 3/0679; G06F 2212/1052; G06F 3/0652; G06F 12/0253; G06F 21/44

(57) ABSTRACT

Various aspects of the subject technology relate to methods, systems, and machine-readable media for selective erase of persistent and non-volatile memory (NVM) devices. The method includes receiving a notification of a deleted block, the deleted block including sensitive data located in a memory block of an NVM device. The method also includes marking an address of the deleted block as read protected to prevent reading of the deleted block. The method also includes assigning a criticality ranking and a wear out level to the deleted block. The method also includes prioritizing write commands to the deleted block based on the criticality ranking and the wear out level of the deleted block. The method also includes overwriting the deleted block with zeroes or a specific pattern to permanently erase the sensitive data.

### BACKGROUND

Data protection and security are of utmost importance for all organizations and vital for mission critical sensitive organizations including federal, government, military, and health organizations, which have laws governing data protection and security. Data operated on and used needs to be handled carefully and requires assurance of security from software and hardware layers of a platform for data at rest and during decommissioning/repurposing of devices. Ability to selectively and securely erase the data from persistent stores of memory is required for all high security applications. Any sensitive data left behind can result in potential data breaches due to device theft and advanced malware attacks on target devices.

Conventional write-zero approaches on blocks to be securely erased as used by traditional secondary stores may be applied to persistent memory and NAND flash-based drives. However, it does not consider the limited program-erase cycles of this new class of memory, and also it will not ensure a secure erase as, in some conventional implementations, the write operations will be mapped to a new block for wear leveling to distribute the writes. In some conventional implementations, redundant copies of the data are still maintained for handling wear out of persistent memory blocks.

### BRIEF DESCRIPTION OF THE DRAWINGS

The following detailed description references the drawings, wherein:

FIG. 1 is a block diagram of an example non-volatile memory (NVM) device;

FIGS. 2A-2C are block diagrams illustrating an example memory block system for selective erase of persistent and NVM devices;

FIG. 3 is a block diagram illustrating an example process for selective erase of persistent and NVM devices;

FIG. 4 is a block diagram illustrating an example write operation for selective erase of persistent and NVM devices;

FIG. 5 illustrates an example flow diagram for selective erase of persistent and NVM devices; and

FIG. 6 is a block diagram illustrating an example computer system with which aspects of the subject technology may be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The persistency of data with non-volatile memory (NVM) implementations such as memristors, scalable persistent memory etc., and NAND flash-based drives/NVM compliant drives bring along the challenges of data security and protection, as persistent memory modules with all their data may end up in the possession of malicious actors through physical theft, cyber-attacks, or through accidental possession from scenarios such as server decommissioning. Selective secure erase of sensitive data and files in persistent store is important to ensure that sensitive data is permanently erased after it is generated and consumed.

Conventional delete operations on a file in persistent memory/NAND flash-based drives only updates file-system data structures (e.g., file inode data in LINUX) to mark the blocks as unused. However, the data would still be present in the end device. In some conventional approaches, operations to read/write will be mapped to a new block for managing wear levelling of the device. In other conventional implementations, redundant copies of the data are maintained for handling wear out of persistent memory blocks. Although applications assume that data is deleted after a delete operation, it may still be present in a backing store.

Conventional approaches include selective erase of contents in secondary storage media by writing zeros or a specific pattern on blocks containing sensitive data. However, traditional solutions do not account for the limited program-erase cycles of persistent memory and NAND flash-based drives. Employing a write-zero approach to erase all blocks after a delete operation will result in accelerated wear out of the device due to excessive write/erase cycles impacting warranty cost and performance. This is compounded when sensitive and secret data are created and deleted many times over a period of time. The current solutions also do not ensure a secure erase, as in some implementations all the write operations are mapped to a new block for wear levelling to distribute the writes. As a result, traditional write-zero approaches for erasing a set of blocks will not ensure the data in the mapped/redundant blocks is erased. This is in contrast to HDD drives, where data may be deleted from file systems and sectors without wear levelling issues. Therefore, there is a need for solutions that may handle erasure of sensitive data in persistent and NVM devices.

This disclosure proposes an apparatus and method for selectively securing and protecting persistent memory and flash-based drives (e.g., NVMe drives) by enabling an optimal selective secure erase feature, which considers wear levelling, redundant blocks, and provides security of data while honoring device endurance levels by using limited program-erase cycles. The solution enables selective secure erase of new generation persistent and NVM based devices, by using a method and apparatus that uses modifications in the operating system (OS) to send delete requests to an NVM controller, and an algorithm in the NVM controller to protect and manage the deleted blocks.

The disclosed methods, systems, and machine-readable media address a problem in traditional spectral scan techniques tied to computer technology, namely the technical problem of securely and permanently erasing sensitive data. The disclosed methods, systems, and machine-readable media solve this technical problem by providing a solution also rooted in computer technology, namely, by enabling an optimal selective secure erase feature, which considers wear levelling, redundant blocks, and provides security of data while honoring device endurance levels by using limited program-erase cycles.

The disclosed subject technology further provides improvements to the functioning of the computer itself because it increases efficiency in permanently erasing secure data, improves security, and decreases power consumption. Specifically, a selective secure erase feature utilizes limited program-erase cycles to improve endurance of memory devices. Additional improvements includes the ability to read protect data prior to permanent deletion and the option for an immediate secure erase, regardless of wear levelling and criticality ranking. Further improvements includes the ability to selectively erase blocks when sensitive data needs to be cleared from the persistent store, when a whole drive format is not an option. Additional features ensure all redundant blocks and mapped blocks are erased without any copies of sensitive data left behind. As described herein, an optimal algorithm considers limited program-erase cycles of persistent memory and NAND flash-based drives, and preserves the drive life, while enabling selective secure erase.

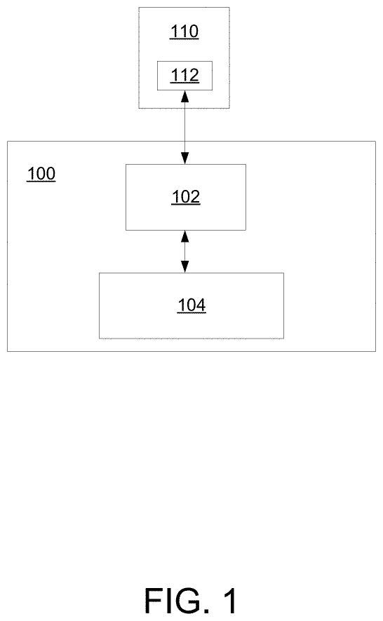

FIG. 1 is a block diagram of an example non-volatile memory (NVM) device 100, according to certain aspects of the present disclosure. The NVM device 100 includes a controller 102 coupled to storage 104. An OS 110 may send commands and receive feedback from the NVM device 100 through the controller 102. It is understood that the NVM device may include memristors, scalable persistent memory, NAND flash-based drives, NVM compliant drives, etc.

According to an aspect of the present disclosure, NVM management of deleted blocks may be performed. For example, when a critical file in the storage 104 of the NVM device 100 (or other persistent memory device) is requested to be erased, a file-system/NVM driver 112 in the OS 110 may include functionality to update corresponding file-system data structures (e.g., inodes for LINUX) in the NVM device 100. The driver 112 may also engage the controller 102 to manage critical blocks associated with the critical file. The OS 110 may also send a criticality ranking of the deleted blocks to the controller 102.

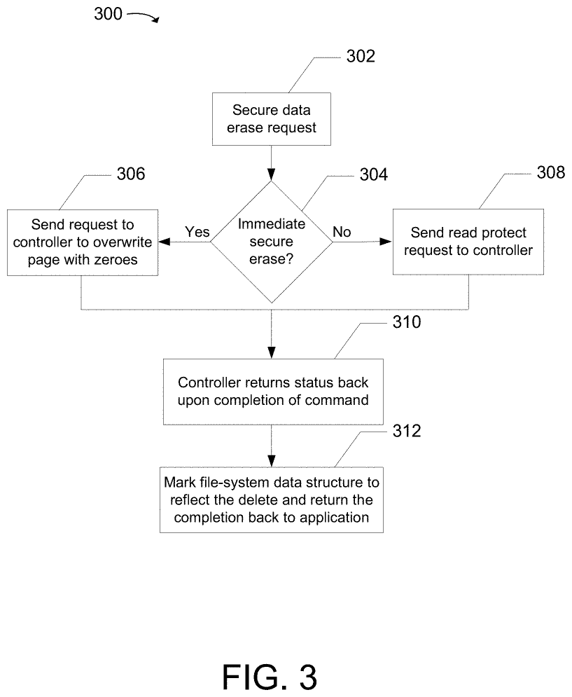

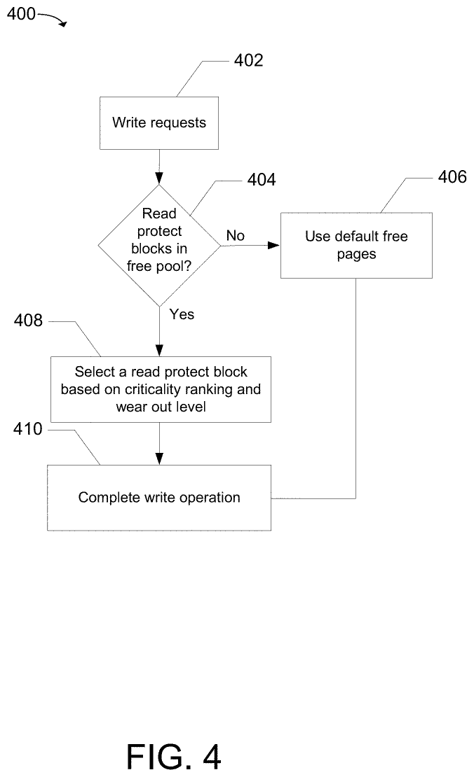

When the controller 102 receives a deleted block notification, the controller 102, which includes a smart and secure block management algorithm as described below in FIGS. 3 and 4, protects the deleted blocks using a read protection logic to prevent reads of the deleted blocks until a power recycle event or until a subsequent write to the same block. For example, firmware on the controller 102 may mark a particular logical block address (LBA)/page as read protected in its internal mapping. The controller 102 may also note the file criticality information provided by the OS 110. Because the read protection will be cleared only upon a next write to the same page, any read request coming into this page will not be honored until the read protection is unset.

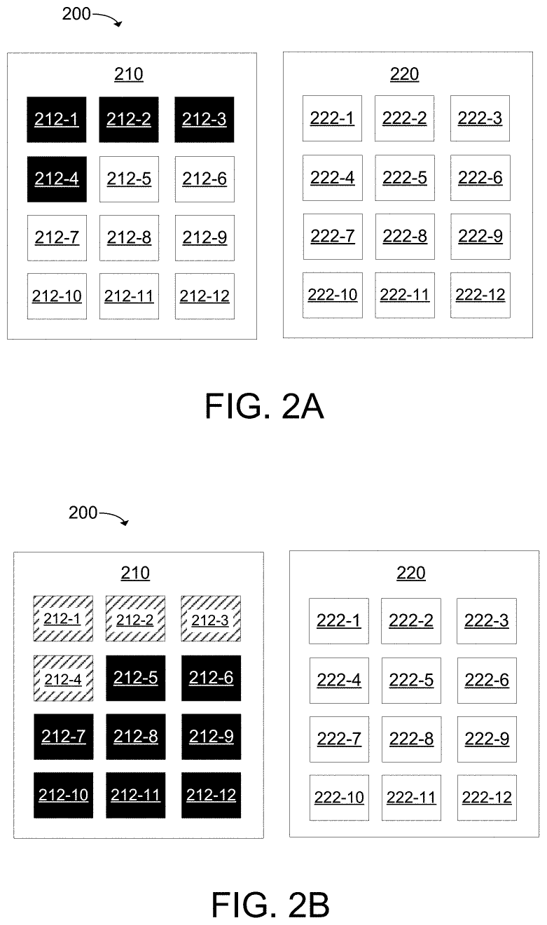

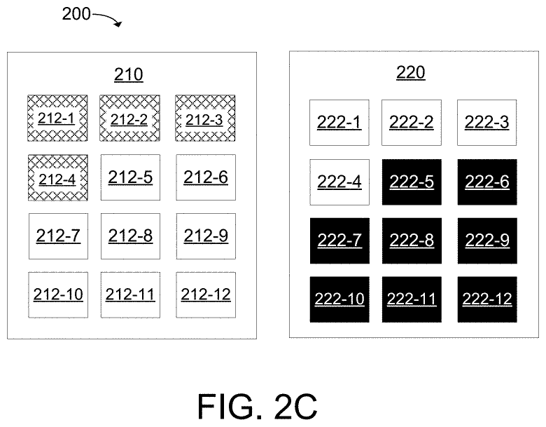

FIGS. 2A-2C are block diagrams illustrating an example memory block system 200 for selective erase of persistent and NVM devices, according to certain aspects of the present disclosure.

Referring to FIG. 2A, a memory block system 200 may include a first memory block 210 and a second memory block 220. For example, the first memory block 210 may be adjacent to the second memory block 220. The first memory block 210 may include multiple pages 212-1 to 212-12. Similarly, the second memory block 220 may include multiple pages 222-1 to 222-12. Free pages are illustrated as white, such as pages 212-5 to 212-12 in the first memory block 210, and pages 222-1 to 222-12 in the second memory block. Pages with data written to them are illustrated as blackened, such as pages 212-1 to 212-4 in the first memory block 210.

According to an aspect of the present disclosure, sensitive data may be written to pages 212-1 to 212-4 of the first memory block 210. For example, the sensitive data may occupy all of the pages 212-1 to 212-4. In an implementation, first sensitive data may occupy some of the pages (e.g., page 212-1), second sensitive data may occupy other pages (e.g., pages 212-2 to 212-3), and third sensitive data may occupy the rest of the pages (e.g., page 212-4). It is understood that data may be written to the pages in any order of combinations.

As illustrated in FIG. 2B, subsequent delete commands to erase the sensitive data may result in pages 212-1 to 212-4 being marked unavailable (i.e., shown as striped). Although the pages themselves are marked unavailable, no new data may be written over the sensitive data unless all the pages 212-1 to 212-12 are marked free (e.g., shown as white). Also illustrated in FIG. 2, subsequent write commands result in data being written to pages 212-5 to 212-12. For example, some of the pages may include new data, and other pages may include backup, replacement, or duplicate data of pages 212-1 to 212-4.

Referring to FIG. 2C, a garbage collection function may copy the data in pages 212-5 to 212-12 to pages 222-5 to 222-12 (e.g., shown as black) of the second memory block 220. This allows for all of the pages 212-1 to 212-12 of the first memory block 210 to be marked free. New data may now overwrite old data previously in the pages 212-1 to 212-12. For example, a write-zero operation may overwrite the pages with zeros or a specific pattern to permanently delete data previously stored there. Pages 212-1 to 212-12 may comprise a free pool of the garbage collector function.

According to aspects of the present disclosure, pages 212-1 to 212-4 may also be marked as read protected (e.g., shown as cross-checkered) to prevent read commands from accessing the sensitive data prior to the sensitive data being overwritten. Additionally, a criticality ranking and/or wear out level may be assigned to the pages 212-1 to 212-4 based on criticality of the sensitive data and how many times the pages were overwritten. In this way, overwriting of the pages 212-1 to 212-4 may be prioritized based on criticality and wear. For example, a page with a highest criticality ranking and a lowest wear out level will be prioritized over all others for rewrites. In some implementations, data may be categorized in an order of criticality, such as public, sensitive, classified, top secret, etc., which may correspond to criticality rankings. For example, top secret data may only be kept for a short period of time, and marked for permanent deletion shortly after erasure (e.g., a few seconds, minutes, or hours). Similar time periods may be designated for other categories of data (e.g., a few seconds, minutes, or hours for sensitive or classified data). It is understood that other time periods are permitted, according to sensitivity of the data.

FIG. 3 is a block diagram 300 illustrating an example process for selective erase of persistent and NVM devices, according to certain aspects of the present disclosure. At block 302, a secure data erase request is received. For example, the request may be received from an OS (e.g., OS 110 of FIG. 1). At block 304, it is determined whether the erase request includes an immediate secure erase request. If no, then at block 308 a read protect request is sent (e.g., from a driver) to a controller (e.g., controller 102 of FIG. 1). If yes, then at block 306 a request is sent (e.g., from a driver) to the controller to overwrite the corresponding page with zeroes or another specific pattern. At block 310, after sending either the read protect request or the overwrite request, the controller returns a status back upon completion of either the read protect request or the overwrite request. At block 312, a file-system data structure may be marked to reflect the delete and return the completion back to an application (e.g., the driver 112 of FIG. 1).

According to an aspect, information about the deleted block may be maintained inside the controller, and as soon as the information reaches the controller, the controller marks the deleted block as read protected. For example, the deleted block will not be allowed to be read until a subsequent power cycle or other reset event. For example, as soon as the next power cycle occurs, everything in that block (i.e., marked as deleted) will be permanently erased. In an implementation, the logic of maintaining these blocks inside a memory device (e.g., a NVM flash memory device) may be inside the controller. These features prevent malware attacks from reading deleted sensitive data, and situations where devices are disconnected/decommissioned.

According to additional aspects, classification of the data (e.g., criticality rankings) may be passed to the controller when the data is written to memory. When those blocks are deleted, the classifications may be utilized to determine a criticality ranking for subsequent overwrites. For example, a garbage collector function may include read protected pages to its free pool, as shown in FIG. 2C. These read protected pages will be given high priority for next page re-use. Also, on any next write to reuse a specific read protected block, a selection algorithm (e.g., the example process of FIG. 3) may consider a wear out level and a criticality ranking of the block.

FIG. 4 is a block diagram 400 illustrating an example write operation for selective erase of persistent and NVM devices. At block 402, write requests are received at a controller (e.g., the controller 102 of FIG. 1). At block 404, it is determined whether read protect blocks are in a free pool (e.g., of a garbage collector function). If no, then at block 406 default free pages are utilized for the write (e.g., pages 212-5 to 212-12 of FIG. 2C). If yes, then at block 408 a read protected block is selected based on criticality ranking and/or wear out level for the write (e.g., pages 212-1 to 212-4 of FIG. 2C). At block 410, the write operation is completed on either the default free pages or the read protected block.

Aspects of the present disclosure may provide for deleted block garbage collection and reuse management. For example, a garbage collector (e.g., a garbage collection function) may include all read protected pages to its free pool. The read protected pages in the free pool may be given highest priority for next page re-use. On any next write, a specific read protected block may be re-used, and a selection algorithm (e.g., the example process of FIG. 4) considers a wear out level of the device/block and a criticality ranking of the block.

According to additional aspects, on a controller power cycle/reset event, any pending read protected blocks may be erased. For cases where memory drives may be separated from the controllers, signature validations may be utilized to match controller firmware and memory drive firmware, so that the read protection on the blocks is always honored even when the memory drives are moved. This ensures that there are no read protect blocks pending during power off or when the drive is being decommissioned/moved. This also ensures that any kernel or root administrator level malwares cannot access the deleted blocks due to the protection from the controller. Erase logic within the controller firmware may also erase bad blocks and redundant blocks corresponding to the block being deleted.

In an implementation, an immediate selective secure erase option is also provided for situations when sensitive data needs to be erased immediately with no lags/delays. For example, on receiving an immediate selective secure erase command, a write-zero request, along with an extra bit in a write command, may indicate that it is an erase operation onto the same page. The request may be sent to the firmware by the respective driver/file system. The extra bit may ensure that the erase is carried out on the desired page overriding the wear leveling feature, which would otherwise write zeroes on a different location.

This protection mechanism not only secures the deleted block, but also helps wear out of the device by reducing erase/write cycles after every operation, thereby extending the life of the device. The mechanism that allows deletion of erased blocks at every power cycle also helps to protect data theft after physical attacks while extending the life of storage devices when compared to solutions that delete data after every delete/write operation.

The disclosed selective secure erase feature on persistent memory and flash-based non-volatile memory complaint drives utilizes limited program-erase cycles without compromising endurance of memory drives. The algorithms proposed also address wear levelling and redundant block issues by ensuring that pages having sensitive data are deleted or read protected. Aspects of the disclosure also provide enhanced logic based on file ranking to select the highest ranked file for a next write operation to ensure the pages with critical data are selected first for an erase-write. The disclosed logic further addresses deletion of any pending read protect blocks on a reset, or shut down to ensure the data is unavailable, for scenarios such as theft and/or server decommissioning. The described aspects may be applicable to persistent memory as well as NAND flash-based non-volatile memory complaint drives. Aspects of the present disclosure, such as file ranking, may also be applied and extended to other memory drives, which include a secure erase feature in place. Further, each program-erase cycle may include an overhead in terms of power consumption. By limiting the number of program-erase cycles during erase operations, overall power consumption may be optimized.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

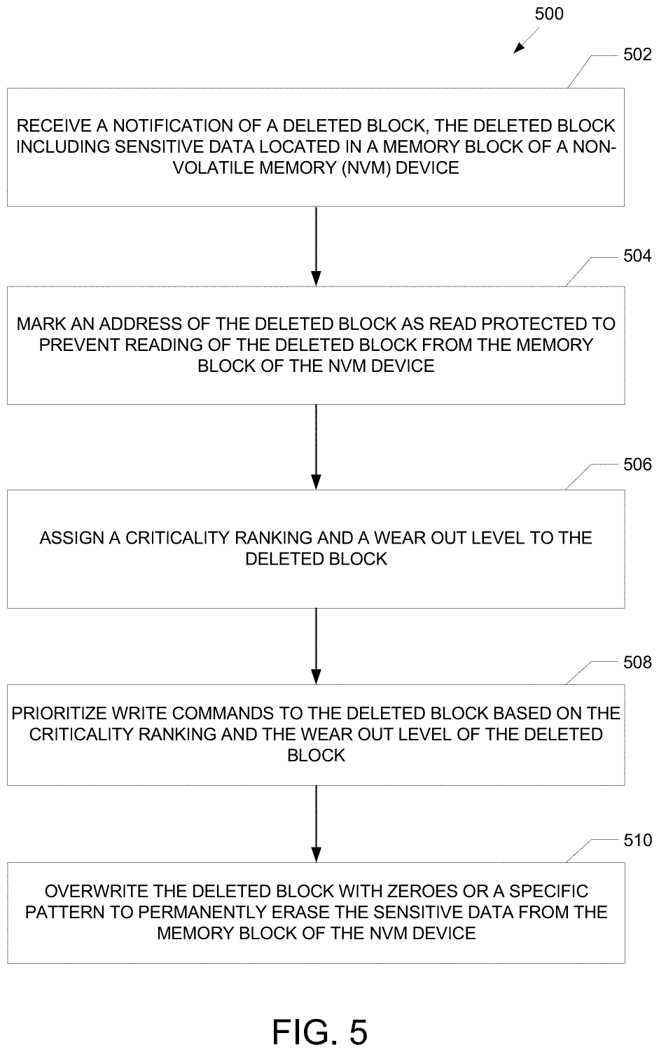

FIG. 5 illustrates an example flow diagram (e.g., process 500) for selective erase of persistent and NVM devices, according to certain aspects of the disclosure. For explanatory purposes, the example process 500 is described herein with reference to the systems and architectures of FIGS. 1-4. Further, for explanatory purposes, the blocks of the example process 500 are described herein as occurring in serial, or linearly. However, multiple blocks of the example process 500 may occur in parallel. In addition, the blocks of the example process 500 need not be performed in the order shown and/or one or more of the blocks of the example process 500 need not be performed. For purposes of explanation of the subject technology, the process 500 will be discussed in reference to FIGS. 1-4.

At block 502, a notification of a deleted block is received, the deleted block including sensitive data located in a memory block of an NVM device. At block 504, an address of the deleted block is marked as read protected to prevent reading of the deleted block from the memory block of the NVM device. At block 506, a criticality ranking and a wear out level are assigned to the deleted block. At block 508, write commands are prioritized to the deleted block based on the criticality ranking and the wear out level of the deleted block. At block 510, the deleted block is overwritten with zeroes or a specific pattern to permanently erase the sensitive data from the memory block of the NVM device.

According to an aspect, the process 500 further includes updating a file-system data structure related to the sensitive data based on the notification of the deleted block. For example, inodes in LINUX may be updated based on the sensitive data.

According to an aspect, the process 500 further includes preventing reads of the deleted block until at least one of a power recycle event or a subsequent write to the deleted block. For example, the deleted block may be permanently erased upon a power recycle event.

According to an aspect, the process 500 further includes validating signatures of controller firmware and memory drive firmware to ensure read protection of the deleted block after decommissioning or moving of a memory device storing the sensitive data. For example, signatures of controller firmware and memory drive firmware may be validated after moving or decommissioning to protect against attacks.

According to an aspect, the process 500 further includes overwriting redundant blocks corresponding to the deleted block. According to an aspect, the process 500 further includes receiving an immediate erase request, and overwriting the deleted block with zeroes or a specific pattern to permanently erase the sensitive data, regardless of the wear out level of the deleted block.

According to an aspect, the process 500 further includes adding the deleted block to a free pool of a garbage collector function, the garbage collector function overwriting the deleted block during execution. For example, the garbage collector function may prioritize overwriting read protected blocks.

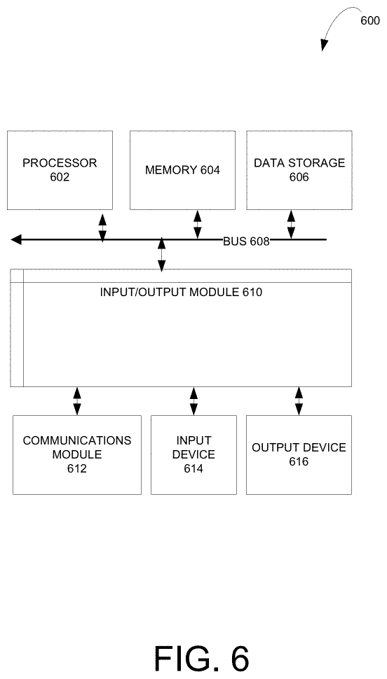

FIG. 6 is a block diagram illustrating an exemplary computer system 600 with which the devices and systems of FIGS. 1, and 2A-2C may be implemented. In certain aspects, the computer system 600 may be implemented using hardware or a combination of software and hardware, either in a dedicated server, integrated into another entity, or distributed across multiple entities.

Computer system 600 includes a bus 608 or other communication mechanism for communicating information, and a processor 602 coupled with bus 608 for processing information. By way of example, the computer system 600 may be implemented with one or more processors 602. Processor 602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 600 can include, in addition to hardware, code that creates an execution environment for the computer program in question, for example, code that constitutes processor firmware, a protocol stack, a database management system, an operating system, or a combination of one or more of them stored in an included memory 604, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 608 for storing information and instructions to be executed by processor 602. The processor 602 and the memory 604 can be supplemented by, or incorporated in, special purpose logic circuitry.

The instructions may be stored in the memory 604 and implemented in one or more computer program products, i.e., one or more modules of computer program instructions encoded on a computer-readable medium for execution by, or to control the operation of, the computer system 600, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multi-paradigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 604 may also be used for storing temporary variable or other intermediate information during execution of instructions to be executed by processor 602.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 600 further includes a data storage device 606 such as a magnetic disk or optical disk, coupled to bus 608 for storing information and instructions. Computer system 600 may be coupled via input/output module 610 to various devices. The input/output module 610 can be any input/output module. Exemplary input/output modules 610 include data ports such as USB ports. The input/output module 610 is configured to connect to a communications module 612. Exemplary communications modules 612 include networking interface cards, such as Ethernet cards and modems. In certain aspects, the input/output module 610 is configured to connect to a plurality of devices, such as an input device 614 and/or an output device 616. Exemplary input devices 614 include a keyboard and a pointing device, e.g., a mouse or a trackball, by which a user can provide input to the computer system 600. Other kinds of input devices 614 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 616 include display devices such as an LCD (liquid crystal display) monitor, for displaying information to the user.

According to one aspect of the present disclosure, the devices and systems can be implemented using a computer system 600 in response to processor 602 executing one or more sequences of one or more instructions contained in memory 604. Such instructions may be read into memory 604 from another machine-readable medium, such as data storage device 606. Execution of the sequences of instructions contained in the main memory 604 causes processor 602 to perform the process steps described herein. One or more processors in a multi-processing arrangement may also be employed to execute the sequences of instructions contained in memory 604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back-end component, e.g., such as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 600 can include clients and servers. A client and server are generally remote from each other and typically interact through a communication network. The relationship of client and server arises by virtue of computer programs running on the respective computers and having a client-server relationship to each other. Computer system 600 can be, for example, and without limitation, a desktop computer, laptop computer, or tablet computer. Computer system 600 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 602 for execution. Such a medium may take many forms, including, but not limited to, non-volatile media, volatile media, and transmission media. Non-volatile media include, for example, optical or magnetic disks, such as data storage device 606. Volatile media include dynamic memory, such as memory 604. Transmission media include coaxial cables, copper wire, and fiber optics, including the wires that comprise bus 608. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A method, comprising:
receiving a notification of a deleted block, the deleted block comprising sensitive data located in a memory block of a non-volatile memory (NVM) device;
marking an address of the deleted block as read protected to prevent reading of the deleted block from the memory block of the NVM device;
assigning a criticality ranking and a wear out level to the deleted block;
prioritizing write commands to the deleted block based on the criticality ranking and the wear out level of the deleted block; and
overwriting the deleted block with zeroes or a specific pattern to permanently erase the sensitive data from the memory block of the NVM device.

2. The method of claim 1, further comprising:
updating a file-system data structure related to the sensitive data based on the notification of the deleted block.

3. The method of claim 1, further comprising:
preventing reads of the deleted block until at least one of a power recycle event or a subsequent write to the deleted block.

4. The method of claim 1, further comprising:
validating signatures of controller firmware and memory drive firmware to ensure read protection of the deleted block after decommissioning or moving of a memory device storing the sensitive data.

5. The method of claim 1, further comprising:
overwriting redundant blocks corresponding to the deleted block.

6. The method of claim 1, further comprising:
receiving an immediate erase request; and
overwriting the deleted block with zeroes or a specific pattern to permanently erase the sensitive data, regardless of the wear out level of the deleted block.

7. The method of claim 1, further comprising:
adding the deleted block to a free pool of a garbage collector function, the garbage collector function overwriting the deleted block during execution.

8. A system, comprising:
a memory; and
a processor executing instructions from the memory to:
receive a notification of a deleted block, the deleted block comprising sensitive data located in a memory block of a non-volatile memory (NVM) device;
mark an address of the deleted block as read protected to prevent reading of the deleted block from the memory block of the NVM device;
assign a criticality ranking and a wear out level to the deleted block;
prioritize write commands to the deleted block based on the criticality ranking and the wear out level of the deleted block; and
overwrite the deleted block with zeroes or a specific pattern to permanently erase the sensitive data from the memory block of the NVM device.

9. The system of claim 8, wherein the processor further executes the instructions from the memory to:
update a file-system data structure related to the sensitive data based on the notification of the deleted block.

10. The system of claim 8, wherein the processor further executes the instructions from the memory to:
prevent reads of the deleted block until at least one of a power recycle event or a subsequent write to the deleted block.

11. The system of claim 8, wherein the processor further executes the instructions from the memory to:
validate signatures of controller firmware and memory drive firmware to ensure read protection of the deleted block after decommissioning or moving of a memory device storing the sensitive data.

12. The system of claim 8, wherein the processor further executes the instructions from the memory to:
overwrite redundant blocks corresponding to the deleted block.

13. The system of claim 8, wherein the processor further executes the instructions from the memory to:
receive an immediate erase request; and
overwrite the deleted block with zeroes or a specific pattern to permanently erase the sensitive data, regardless of the wear out level of the deleted block.

14. The system of claim 8, wherein the processor further executes the instructions from the memory to:
add the deleted block to a free pool of a garbage collector function, the garbage collector function overwriting the deleted block during execution.

15. A non-transitory machine-readable storage medium encoded with instructions executable by at least one hardware processor of a network device, the non-transitory machine-readable storage medium comprising instructions to:
receive a notification of a deleted block, the deleted block comprising sensitive data located in a memory block of a non-volatile memory (NVM) device;
mark an address of the deleted block as read protected to prevent reading of the deleted block from the memory block of the NVM device;
assign a criticality ranking and a wear out level to the deleted block;
prioritize write commands to the deleted block based on the criticality ranking and the wear out level of the deleted block;
overwrite the deleted block with zeroes or a specific pattern to permanently erase the sensitive data from the memory block of the NVM device; and
prevent reads of the deleted block until at least one of a power recycle event or a subsequent write to the deleted block.

16. The non-transitory machine-readable storage medium of claim 15, further comprising instructions to:
update a file-system data structure related to the sensitive data based on the notification of the deleted block.

17. The non-transitory machine-readable storage medium of claim 15, further comprising instructions to:
validate signatures of controller firmware and memory drive firmware to ensure read protection of the deleted block after decommissioning or moving of a memory device storing the sensitive data.

18. The non-transitory machine-readable storage medium of claim 15, further comprising instructions to:
overwrite redundant blocks corresponding to the deleted block.

19. The non-transitory machine-readable storage medium of claim 15, further comprising instructions to:
receive an immediate erase request; and
overwrite the deleted block with zeroes or a specific pattern to permanently erase the sensitive data, regardless of the wear out level of the deleted block.

20. The non-transitory machine-readable storage medium of claim 15, further comprising instructions to:
add the deleted block to a free pool of a garbage collector function, the garbage collector function overwriting the deleted block during execution.
